(19) United States
(12) Patent Application Publication
(10) Pub. No.: US 2021/0131368 A1
(43) Pub. Date: May 6, 2021

(54) Emission Control in an Engine Fuelled with a Combination of a Hydrocarbon Fuel and Hydrogen

(71) Applicant: ULEMCO LIMITED, Aintree, Merseyside (GB)

(72) Inventors: Paul Turner, Brentwood (GB); Trevor Jasper, Brentwood (GB)

(73) Assignee: ULEMCO LTD., Aintree, Liverpool, Merseyside (GB)

(21) Appl. No.: 16/963,220

(22) PCT Filed: Jan. 18, 2019
(86) PCT No.: PCT/GB2019/050145

§ 371 Date: Jul. 18, 2020

(30) Foreign Application Priority Data
Jan. 23, 2018 (GB) 1801092.6

(51) Int. Cl. F02D 41/00; F02D 41/14

(52) U.S. Cl. CPC F02D 41/0027; F02D 19/081; F02D 41/146

(57) ABSTRACT

The invention concerns a method of control of NOx emission from an internal combustion engine fueled with a mixture of a hydrocarbon fuel and hydrogen. The method comprises reducing the hydrogen content of the fuel mixture at high engine loads.

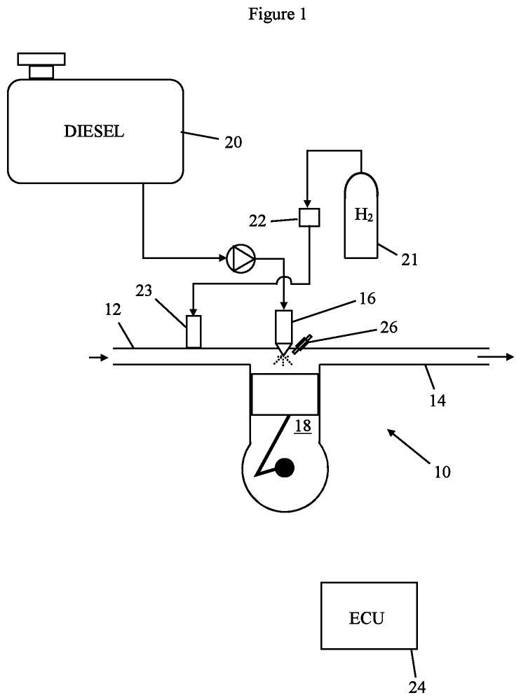

The invention is concerned with emission control in an internal combustion engine fueled with a combination of a hydrocarbon fuel and hydrogen.

There are powerful economic and societal incentives to reduce the consumption of hydrocarbon based fuels in internal combustion engines. Release of carbon by their combustion is thought to be a major contributor to global warming. The Earth's resources of crude oil are finite, and its extraction harms the environment in various ways.

Hydrogen has long been suggested as a substitute for hydrocarbon based fuels and the modern focus on reduction of carbon release into the atmosphere has only increased its attraction in this respect. But for a range of technical and social reasons widespread adoption of hydrogen fueling of vehicles has not taken place at the time of writing.

It is known to fuel internal combustion engines on a controlled mixture of hydrogen and a hydrocarbon fuel. Hydrogen can provide a large proportion of the fuel's energy content, greatly reducing consumption of the hydrocarbon fuel.

This dual fueling approach has numerous potential advantages. It is possible to adapt existing internal combustion engines, especially compression ignition engines conventionally fueled on diesel, to use a hydrogen/hydrocarbon mixture. Hydrogen alone cannot be used to fuel a diesel engine as it does not undergo compression ignition. The diesel component provides the required compression ignition characteristics and serves to ignite the hydrogen. Consumption of diesel can nonetheless be greatly decreased. The engine can typically be run on diesel alone when required, so that the vehicle is not dependent on frequent access to a hydrogen source (which would at present be problematic since refueling stations capable of supplying hydrogen are not uniformly available).

In the modern world, internal combustion engines must meet strict standards in relation to their emission of harmful exhaust products. These harmful products of the combustion process include nitrogen oxides, commonly referred to as NOₓ and comprising nitric oxide (NO) and nitrogen dioxide (NO₂). Control of NOₓ emission is an important theme in automotive engineering and many technologies have been explored and put to practical use in this connection, including the catalytic converters now commonly incorporated in vehicle exhausts.

NOₓ results from reaction of atmospheric oxygen with nitrogen during combustion. In some cases a proportion of the nitrogen is contributed by the fuel itself, since fuels derived from crude oil are nitrogen bearing. If an engine were fueled on hydrogen alone, the hydrogen fuel itself would contribute no nitrogen. But even in this case the high temperature conditions created in an engine cause atmospheric nitrogen to react with atmospheric oxygen to create unwanted NOₓ.

The inventors have found that a dual fueled engine running on a combination of diesel fuel and hydrogen provides low emissions at part load (moderate engine power) due to hydrogen's ability to run at very lean mixtures (meaning that much of the available oxygen is burnt with the hydrogen to form water) and hydrogen's high energy content per unit mass. However, as an engine of this type approaches full load, a richer ratio of air to hydrogen gives greater NOₓ production, which is problematic.

The invention provides a method of control of NOₓ emission from an internal combustion engine fueled with a mixture of a hydrocarbon fuel and hydrogen, the method comprising reducing the hydrogen content of the fuel mixture at high engine loads.

A specific embodiment of the present invention will now be described, by way of example only, with reference to the accompanying drawing, which is a schematic representation of parts of an engine operable in accordance with the invention.

The embodiment of the invention described herein is implemented in a compression ignition internal combustion engine, and specifically a diesel engine 10 represented in highly schematic form in the drawing, having an air intake manifold 12, an exhaust 14, and a set of fuel injectors 16 associated with respective combustion chambers 18, only one of which is seen in the drawings. Diesel fuel is drawn from a tank 20 and supplied to the injectors 16. Hydrogen is stored in pressure vessel 21 in liquid or gaseous form and at high pressure (which purely by way of example may be in the range of 35 to 70 MPa), and is supplied to the engine air intake manifold via a regulator unit 22 used to regulate the hydrogen pressure, so that hydrogen injectors 23 and diesel injectors 16 can supply the diesel/hydrogen mixture.

Operation of the engine is under the control of an electronic processing system represented in the drawing as an ECU (electronic control unit) 24. Control connections from the ECU 24 are not represented in the drawings for the sake of simplicity, but the ECU serves, in response to input data from a range of sensors, to control among other items:
the regulator unit 22 and hydrogen injector 23, and through it the quantity of hydrogen supplied to the combustion chambers 18;
the fuel injectors 16, and through them the quantity of diesel supplied to the combustion chambers 18; and
glow plugs 26 associated with the combustion chambers 18.

The ECU regulates diesel and hydrogen supply to achieve (a) a desired input of fuel energy to the engine, which varies according to factors including the driver's power demand, and (b) a desired balance between diesel and hydrogen fueling.

Trials by the inventors have shown that the combustion temperature and burn rates achieved when dual fueling an engine of this type using diesel and hydrogen can be similar to those achieved when running on diesel alone over a range of engine loads. At part load, low NOₓ emissions can be achieved due to the ability of hydrogen to run in a lean fuel/air mixture, and its high energy density. But in tests carried out by the inventors it has been found that at mid to high engine loads, if a high hydrogen content is maintained then NOₓ emissions can increase rapidly despite the combustion temperatures not changing significantly. The reason is not immediately apparent.

It is not intended to limit the scope of the invention by reference to any theoretical explanation of this observed phenomenon. But analysis suggests that the explanation lies in a reduction in local CO (carbon monoxide) formation during combustion, due to the high hydrogen content of the fuel.

CO is produced by combustion of hydrocarbon fuel. In a diesel engine with stratified charge, CO forms locally around the rich droplets of diesel fuel as they combust. CO reacts with NOx, reducing emission of both these undesirable exhaust components. But hydrogen combustion provides no CO, since hydrogen fuel contains no carbon. Reduction of the diesel proportion of the fuel is thought to reduce the available CO and result in the observed increase of NOₓ emission.

To control NOₓ emissions, the hydrogen content of the fuel is reduced at high engine loads in accordance with the present invention.

The required control over the hydrogen/hydrocarbon balance of the fuel mixture may be based solely or at least partly on sensed NOₓ emission. A sensor 28 in the exhaust is used to detect the level of NOₓ and to reduce the hydrogen proportion of the fuel if the NOₓ level is too high. The required control can be carried out in closed loop fashion, e.g. using a PID (proportional integral differential) type of control logic.

Additionally or alternatively the required control of the hydrogen/hydrocarbon may be exercised using a map of engine performance. A three-dimensional map having axes of demanded engine power, temperature and engine speed may for example be implemented in the ECU 24, giving as output (for any possible combination of these three parameters) a maximum proportion of hydrogen that can be used without providing an unacceptable level of NOₓ. This map is then used by the ECU in control of the regulator unit 22 and the injectors 16.

As an example, hydrogen may provide 75-95% of the energy content of the fuel whilst the engine is running at loads up to two thirds of its maximum, and 30-40% when the engine operates at full permitted load.

1. A method of control of NO_{X} emission in an exhaust from an internal combustion engine fueled with a mixture of a hydrocarbon fuel and hydrogen, the method comprising reducing the hydrogen content of the fuel mixture at high engine loads.

2. The method as claimed in claim 1, wherein the reduction of hydrogen at high fuel loads provides CO in a combustion chamber of the engine to react with NO_{X} in the combustion chamber and so reduce NOx emission.

3. The method as claimed in claim 1, wherein hydrogen makes up in excess of 60% of an energy content of the fuel provided to the engine at 50% of maximum engine power and less than 40% of the energy content of the fuel provided to the engine at maximum engine power.

4. The method as claimed in claim 1, wherein hydrogen makes up in excess of 75% of an energy content of the fuel provided to the engine at 50% of maximum engine power and less than 40% of the energy content of the fuel provided to the engine at maximum engine power.

5. The method as claimed in claim 1 further comprising sensing NO_{X} in the exhaust from the engine and controlling the proportion of hydrogen to the hydrocarbon fuel in dependence on the sensed NOₓ level.

6. The method as claimed in claim 5, wherein the proportion of hydrogen to the hydrocarbon fuel is controlled in a negative feedback loop, reducing the hydrogen content of the fuel mixture in response to excess sensed NO_{X} in the exhaust.

7. The method as claimed in claim 1, wherein the proportion of hydrogen to the hydrocarbon fuel is controlled using a map of engine performance.

8. The method as claimed in claim 7, wherein the map has axes of engine power demand, engine speed and temperature, and provides as an output of the proportion of hydrogen to the hydrocarbon fuel.

9. An engine controller configured to operate an internal combustion engine according to the method of claim 1.

10. A computer program embodied on a computer readable storage medium which, when run on an engine controller, causes the engine controller to operate an internal combustion engine according to the method of claim 1.

11. An internal combustion engine fueled with a mixture of a hydrocarbon fuel and hydrogen, the engine being configured to implement NO_{X} emission control in an exhaust from the engine by reducing the hydrogen content of the fuel mixture at high engine loads.

12. The internal combustion engine as claimed in claim 11 comprising
a sensor responsive to NO_{X} in the exhaust from the engine; and
a controller configured to respond to excess detected NO_{X} by reducing the hydrogen content of the fuel.

13. The internal combustion engine as claimed in claim 11, wherein the engine is a compression ignition engine.

14. The internal combustion engine as claimed in claim 11 configured to operate to use hydrogen at a level to provide in excess of 60% of the energy content of the fuel for the engine at 50% of maximum engine power and less than 40% of the energy content of the fuel for the engine at maximum engine power.

15. The internal combustion engine as claimed in claim 11 configured to operate to use hydrogen at a level to provide in excess of 75% of the energy content of the fuel for the engine at 50% of maximum engine power and less than 40% of the energy content of the fuel for the engine at maximum engine power.

16. The internal combustion engine as claimed in claim 11 comprising a sensor responsive to NO_{X} in the engine's exhaust, the engine being configured to control the proportion of hydrogen to the hydrocarbon fuel in dependence on the sensed NO_{X} level.

17. An internal combustion engine as claimed in claim 16 in which the proportion of hydrogen to the hydrocarbon fuel is controlled in a negative feedback loop, reducing the hydrogen content of the fuel mixture in response to excess sensed NO_{X} in the exhaust.
